(19) United States
(12) Patent Application Publication
(10) Pub. No.: US 2013/0075336 A1
(43) Pub. Date: Mar. 28, 2013

(54) METHOD AND SYSTEM FOR CONTINUOUS SEPARATION AND PURIFICATION OF GANODERIC ACIDS AND POLYSACCHARIDES

(71) Applicants: Zer-Ran Yu, Chiayi City (TW); Be-Jen Wang, Chiayi City (TW)

(72) Inventors: Zer-Ran Yu, Chiayi City (TW); Be-Jen Wang, Chiayi City (TW)

(21) Appl. No.: 13/241,752

(22) Filed: Sep. 23, 2011

(51) Int. Cl. B01D 61/00; B01D 35/18

(52) U.S. Cl. 210/650; 210/175

(57) ABSTRACT

The present invention provides a method and system for continuous separation and purification of ganoderic acids and polysaccharides, which, via the help of supercritical fluid technology, could feed continuously Ganoderma extract and supercritical solvents at a predefined rate into a separator under operating pressure 10-30 MPa and temperature 40-60° C.; then ganoderic acids, polyphenols and polysaccharides can be separated from Ganoderma extract in the separator; with introduction of membrane purification technology, ganoderic acids, polyphenols and polysaccharides are fed continuously to different purifiers to obtain high-purity ganoderic acids, polyphenols and polysaccharides.

### BACKGROUND OF INVENTION

1. Field of the Invention

The present invention relates generally to Ganoderma extraction technology, and more particularly to a method and system for continuous separation and purification of ganoderic acids and polysaccharides.

2. Description of Related Art

Ganoderma (scientific name: Ganoderma lucidum), a kind of mushroom called as “Lingzhi” in China, is considered as a “magic herb”. In many Asian countries such as: China, South Korea and Japan, Ganoderma is commonly used in traditional medical treatment. According to modern pharmacological researches, Ganoderma has many functions including: anti-tumor, hepatoprotection, anti-oxidation, anti-hypertension and cholesterol reduction. The physiological active components contained in Ganoderma include: ganoderic acids—a kind of terpenoids, polysaccharides, polyphenols, nucleosides and steroids.

With regard to the technologies for increasing the concentration of ganoderic acids and polysaccharides from Ganoderma extract and ginsenosides from Ginseng extract, column chromatography (CC) is used to increase glycoprotein concentration in Ganoderma as illustrated in U.S. Pat. No. 5,334,704, and chromatography is used to increase ginsenosides concentration in ginseng as illustrated in U.S. Pat. No. 7,884,195. However, these methods bring about safety hazards with use of numerous organic solvents. Meanwhile, increasing the concentration of polysaccharides will require numerous organic solvents for precipitation and separation, for instance, polysaccharides are precipitated using numerous methanol and ethanol, and then separated by membrane dialysis and ion colloids, as illustrated in U.S. Pat. No. 6,555,527. Supercritical carbon dioxide is employed in U.S. Pat. No. 7,060,286 to separate oleaginous substances in Ganoderma for cosmetic applications. In other words, the technologies for increasing the concentrations of ganoderic acid, polysaccharides and ginsenosides still need improvement.

### SUMMARY OF THE INVENTION

The primary objective of the present invention is to provide a method and system for continuous separation and purification of ganoderic acids and polysaccharides, which, with introduction of supercritical fluid separation and membrane purification technology, enables continuous separation and purification into high-purity ganoderic acids and polysaccharides without solvent residues and toxicity.

The present invention provides a method for continuous separation and purification of ganoderic acids and polysaccharides. Under the operating conditions of 10-30 MPa and 40-60° C., Ganoderma extract and supercritical solvents are fed continuously at a predefined rate into a separator using supercritical fluid technology; then, ganoderic acids, polyphenols, and polysaccharides are separated from Ganoderma extract in the separator, and next fed continuously to different purifiers to obtain high-purity ganoderic acids, polyphenols, and polysaccharides.

Moreover, the present invention provides a system for continuous separation and purification of ganoderic acids and polysaccharides, which comprising: an accumulator, used to accommodate Ganoderma extract; a separator, linked to the accumulator, and provided with an electric heater for separating ganoderic acids and polysaccharides from fluids; a supercritical fluid container, linked to the separator for providing supercritical fluid; a high-pressure metering pump, linked between the supercritical fluid container and separator; a reactant metering pump, linked between the accumulator and separator; a precooler, linked between the supercritical fluid container and high-pressure metering pump; two preheaters, linked separately between the high-pressure metering pump, sample metering pump and separator; a first purifier, linked to the top of the separator, and provided with an ultrafiltration membrane for purifying ganoderic acid and polyphenols; a second purifier, linked to the bottom of the separator, and provided with a microfiltration membrane for purifying polysaccharides; three electric heaters, set separately into the separator and two purifiers.

### BRIEF DESCRIPTION OF THE DRAWINGS

FIG. 1 is a sketch diagram of the continuous separation system of the preferred embodiment of the present invention.

### DETAILED DESCRIPTION OF THE INVENTION

The features and advantages of the present invention will be more readily understood upon a thoughtful deliberation of the following detailed description of two preferred embodiments of the present invention with reference to the accompanying drawings:

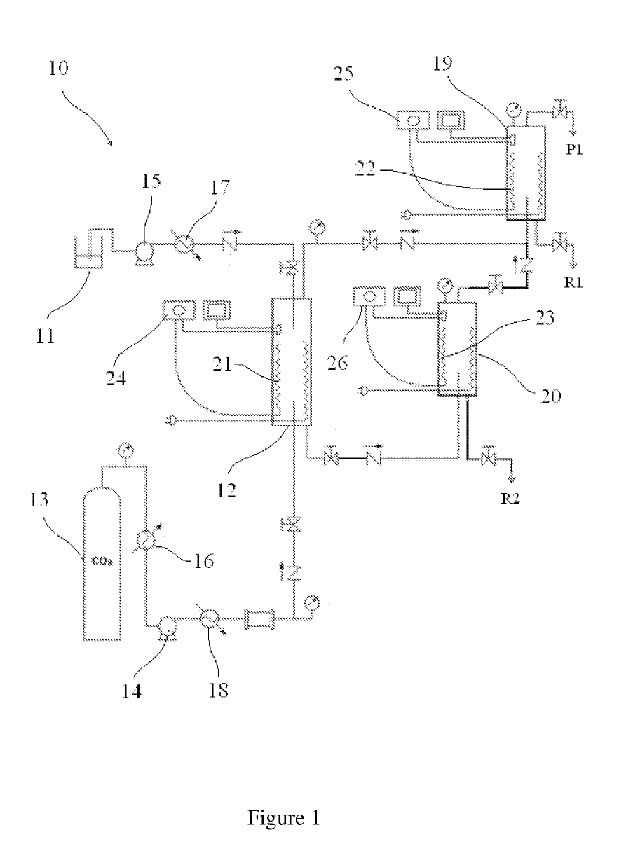

A method for continuous separation and purification of ganoderic acids and polysaccharides is illustrated in FIG. 1, wherein supercritical fluid and membrane purification technologies are used for continuous preparation via a system 10; this system 10 contains: an accumulator 11, a separator 12, a supercritical fluid container 13, a high-pressure metering pump 14, a sample metering pump 15, a precooler 16, two preheaters 17, 18, a first purifier 19, a second purifier 20 and three electric heaters 21, 22, 23, as well as several valves. The accumulator 11 is used to accommodate Ganoderma extract, the separator 12 is linked to the accumulator 11 and comprised of a stainless steel tank body and a monoblock; the supercritical fluid container 13 is a CO₂ steel cylinder that's connected to the separator 12, and used to provide supercritical CO₂; the high-pressure metering pump 14 is linked between the supercritical fluid container 13 and separator 12; the sample metering pump 15 is linked between the accumulator 11 and separator 12; the precooler 16 is linked between the supercritical fluid container 13 and high-pressure metering pump 14; two preheaters 17, 18 are separately linked between the high-pressure metering pump 14, sample metering pump 15 and the separator 12; the first purifier 19 is linked to the top of the separator 12, and comprised of a tank body and ultrafiltration membrane in the tank body (e.g.: Carbosep M2 or M8, 15 kD˜50 kD ZrO₂/TiO₂ ceramic ultrafiltration membrane from Novasep); the second purifier 20 is linked to the bottom of the separator 12, and comprised of a tank body and microfiltration membrane in the tank body (Carbosep M14, 0.14 μm ZrO₂/TiO₂ ceramic microfiltration membrane from Novasep); the electric heaters 21, 22, 23 are separately linked to the separator 12 and two purifiers 19, 20.

In addition, said system 10 comprises three temperature controllers 24, 25, 26, which are separately linked to electric heaters 21, 22, 23 in the separator 12 and purifiers 19, 20.

The following is a description of the method for continuous separation and purification of ganoderic acids and polysaccharides:

Firstly, Ganoderma extract and supercritical fluids are fed continuously at a predefined rate into the separator 12; then, ganoderic acids, polyphenols and polysaccharides are separated from Ganoderma extract in the separator 12, of which, ganoderic acids and polyphenols are separated from the top of the separator 12, and polysaccharides from the bottom of the separator 12; next, ganoderic acids and polyphenols are fed into the first purifier 19 for membrane purification (ultrafiltration), and polysaccharides fed into the second purifier 20 for membrane purification (microfiltration).

In detail, the supercritical fluid container 13 is firstly opened, allowing high-pressure metering pump 14 and valve to control the pressure of the separator 12, and allowing temperature controller 24 to control the temperature of the separator 12; next, the sample metering pump 15 is opened to control the feeding of Ganoderma extract into the separator 12; in such case, Ganoderma extract is separated in the separator 12 to form ganoderic acids, polyphenols and polysaccharides.

When ganoderic acids and polyphenols are fed to the first purifier 19, the pressure difference between the separator 12 and the first purifier 19 is controlled at 1.0˜12 MPa, and the temperature controller 25 is used to control the temperature of the first purifier 19; after ganoderic acids and polyphenols are purified in the first purifier 19, the sample containing polyphenols is collected at top (P1) of the first purifier 19, and the sample containing ganoderic acids collected at bottom (R1) of the first purifier 19.

When polysaccharides are fed to the second purifier 20, the pressure difference between the separator 12 and the second purifier 20 is controlled at 1.0˜1.2 MPa, and the temperature controller 26 is used to control the temperature of the second purifier 20; after polysaccharides is purified in the second purifier 20, the sample containing polysaccharides is collected at bottom (R2) of the second purifier 20. Next, the purified liquid at top of the second purifier 20 is mixed with the separated sample at top of the separator 12, and fed into the first purifier 19.

The following is a detailed description of the settings related to the method for continuous separation and purification of ganoderic acids and polysaccharides:

As for separator 12, its operating temperature is: 40, 50, 60° C., operating pressure: 10, 20, 30 MPa, flow rate 3.0 L/hr of supercritical CO₂ and feed rate 1.0 L/hr of Ganoderma extract. As for the first and second purifiers 19, 20, the operating temperature is: 40, 50, 60° C., and operating pressure: 10, 20, 30 MPa; the pressure difference between the separator 12 and the first/second purifiers 19, 20 is controlled at 1.0˜1.2 MPa.

After Ganoderma extract containing 64.2 mg/mL ganoderic acid and 56.3 mg/mL polysaccharides is separated by the separator 12 of the system 10 at operating temperature (40-60° C.) and pressure (10-30 MPa), ganoderic acid, polyphenols and polysaccharides are collected from top and bottom of the separator 12 as shown in Table 1.

Under operating temperature 40° C. and pressure 10 MPa, ganoderic acids, polyphenols and polysaccharides have poor separation effect due to low solubility in supercritical fluid CO₂ (SC—CO₂). When the temperature is increased to 60° C. and the pressure to 30 MPa, ganoderic acids and polyphenols have optimum separation effect when the solubility in supercritical CO₂ is increased, so ganoderic acids and polyphenols can be separated at top of the separator 12. Polysaccharides is separated at bottom of the separator 12 since its molecular weight is big and the solubility in supercritical CO₂ cannot be increased.

TABLE 1

| | Ganoderic acids | Polyphenols | Polysaccharides |
|---|---|---|---|
| | (mg/mL) | (mg/mL) | (mg/mL) |
| Feed | 64.2 ± 3.7 | 20.6 ± 0.6 | 56.3 ± 3.1 |
| Separator | | | |
| 40° C. | | | |
| 10 MPa | 44.2 ± 2.6 | 14.1 ± 0.8 | 31.2 ± 2.8 |
| 20 MPa | 70.3 ± 3.2 | 22.0 ± 1.5 | 55.7 ± 4.0 |
| 30 MPa | 85.7 ± 2.8 | 26.7 ± 0.8 | 67.6 ± 3.1 |
| 50° C. | | | |
| 10 MPa | 50.5 ± 1.5 | 15.7 ± 0.3 | 34.2 ± 2.5 |
| 20 MPa | 72.6 ± 2.6 | 23.7 ± 1.0 | 67.3 ± 3.2 |
| 30 MPa | 94.5 ± 2.9 | 29.8 ± 1.2 | 79.5 ± 4.1 |
| 60° C. | | | |
| 10 MPa | 55.2 ± 2.7 | 17.3 ± 0.6 | 58.2 ± 2.8 |
| 20 MPa | 104.0 ± 3.8 | 30.2 ± 0.9 | 85.3 ± 3.6 |
| 30 MPa | 106.6 ± 5.6 | 31.4 ± 1.3 | 90.5 ± 4.2 |

As shown in Table 2, after ganoderic acids and polyphenols are purified in the first purifier 19, membrane purification test at operating temperature 40° C. is more prone to bring about fouling and concentration polarization at operating temperature 60° C.; thus, in the case of operating temperature 40° C., ganoderic acids is kept in the first purifier 19, and polyphenols can easily pass the first purifier 19, thus increasing the concentration of ganoderic acids.

Secondly, as shown in Table 2, after polysaccharides is purified in the second purifier 20, polysaccharides due to bigger molecular weight and at temperature 40° C. is more prone to bring about fouling and concentration polarization than at temperature 60° C., thus, in the case of operating temperature 40° C., polysaccharides is much easily kept in the second purifier 20.

TABLE 2

| | Ganoderic acids | Polyphenols | Polysaccharides |
|---|---|---|---|
| | (mg/mL) | (mg/mL) | (mg/mL) |
| Feed | 64.2 ± 3.7 | 20.6 ± 0.6 | 56.3 ± 3.1 |
| Separator | 106.6 ± 5.6 | 21.4 ± 1.3 | 90.5 ± 4.2 |
| Purifier | | | |
| 40° C. | 223.9 ± 11.2 | 100.5 ± 5.6 | 208.2 ± 10.1 |
| 50° C. | 196.1 ± 8.4 | 94.2 ± 6.4 | 190.1 ± 8.4 |
| 60° C. | 183.4 ± 9.1 | 84.8 ± 4.2 | 162.9 ± 6.6 |

The method and system of the present invention for continuous separation and purification of ganoderic acids and polysaccharides could separate and purify ganoderic acids, polyphenols and polysaccharides from Ganoderma extract, with the use of supercritical fluid and membrane purification technologies (for purification through ultrafiltration membrane and microfiltration membrane) as well as continuous separation/purification system; as compared with prior art, the present invention could obtain high-purity ganoderic acids and polysaccharides without solvent residues and toxicity in the process of separation and purification.

After supercritical CO₂ is added into membrane filtration system, this could not only improve membrane flux, reduce fouling and concentration polarization, but also decrease the viscosity and enhance the mass transfer efficiency.

What is claimed is:

1. A method for continuous separation and purification of ganoderic acids and polysaccharides, which, via the help of supercritical fluid technology, could feed continuously Ganoderma extract and supercritical solvents at a predefined rate into a separator under operating pressure 10-30 MPa and temperature 40-60° C.; then ganoderic acids, polyphenols and polysaccharides can be separated from Ganoderma extract in the separator; with introduction of membrane purification technology, ganoderic acids, polyphenols and polysaccharides are fed continuously to different purifiers to obtain high-purity ganoderic acids, polyphenols and polysaccharides.

2. The method defined in claim 1, wherein, ganoderic acids and polyphenols are fed continuously to a purifier with ultrafiltration membrane, and polysaccharides fed continuously to a purifier with microfiltration membrane.

3. The method defined in claim 2, wherein said purifiers are made of stainless steel tanks, and the ultrafiltration and microfiltration membranes are made of ceramic filtration membranes.

4. The method defined in claim 3, wherein said ultrafiltration and microfiltration membranes are made of ZrO₂/TiO₂ ceramic filtration membranes.

5. The method defined in claim 4, wherein said ultrafiltration membrane is ZrO₂/TiO₂ ceramic ultrafiltration membrane of molecular weight 15 kD˜50 kD, and said microfiltration membrane is ZrO₂/TiO₂ ceramic microfiltration membrane of porosity 0.14 μm.

6. The method defined in claim 1, wherein said supercritical fluid refers to supercritical CO₂.

7. The method defined in claim 1, wherein Ganoderma extract is fed at 1.0 L/hr into a separator, and supercritical CO₂ fed at 3.0 L/hr into a separator.

8. The method defined in claim 1, wherein ganoderic acids and polyphenols are separated at top of the separator, and polysaccharides separated at bottom of the separator.

9. The method defined in claim 1, wherein said optimum operating condition of the separator is: pressure 30 MPa, and temperature 60° C.

10. The method defined in claim 1, wherein said optimum operating condition of two purifiers is: temperature 40° C.

11. The method defined in claim 1, wherein said pressure difference between the separator and two purifiers is controlled at 1.0˜1.2 MPa.

12. The system defined in claim 1, wherein it comprising:
an accumulator, used to accommodate Ganoderma extract;
a separator, linked to the accumulator, and provided with an electric heater for separating ganoderic acids and polysaccharides from fluids;
a supercritical fluid container, linked to the separator for providing supercritical fluid;
a high-pressure metering pump, linked between the supercritical fluid container and separator;
a sample metering pump, linked between the accumulator and separator;
a precooler, linked between the supercritical fluid container and high-pressure metering pump;
two preheaters, linked separately between the high-pressure metering pump, sample metering pump and separator;
a first purifier, linked to the top of the separator, and provided with an ultrafiltration membrane for purifying ganoderic acids and polyphenols;
a second purifier, linked to the bottom of the separator, and provided with a microfiltration membrane for purifying polysaccharides; and
three electric heaters, set separately into the separator and two purifiers.

13. The system defined in claim 12, wherein said separator is comprised of a tank body and a stainless steel monoblock; the temperature controller is set in the tank body.

14. The system defined in claim 12, wherein said first purifier is comprised of a tank body and ultrafiltration membrane in the tank body; the temperature controller is set in the tank body; the second purifier is comprised of a tank body and microfiltration membrane in the tank body.

15. The system defined in claim 12, wherein said supercritical fluid container accommodates supercritical CO₂.

16. The system defined in claim 14, wherein said ultrafiltration and microfiltration membranes are made of ZrO₂/TiO₂ ceramic ultrafiltration membranes.

17. The system defined in claim 16, wherein said ultrafiltration membrane is ZrO₂/TiO₂ ceramic ultrafiltration membrane of molecular weight 15 kD˜50 kD, and said microfiltration membrane is ZrO₂/TiO₂ ceramic microfiltration membrane of porosity 0.14 μm.

18. The system defined in claim 12, wherein three temperature controllers are linked to electric heaters in the separator and two purifiers.
